(19) United States
(12) Patent Application Publication
(10) Pub. No.: US 2021/0002812 A1
(43) Pub. Date: Jan. 7, 2021

(54) APPLIANCE FOR DRYING LAUNDRY

(71) Applicant: BSH HAUSGERATE GMBH, München (DE)

(72) Inventors: ALVARO HARBACH, BERLIN (DE); REINHARD HEYDER, BERLIN (DE); ANDREAS STOLZE, FALKENSEE (DE)

(21) Appl. No.: 16/977,328

(22) PCT Filed: Feb. 18, 2019
(86) PCT No.: PCT/EP2019/053911

§ 371 Date: Sep. 1, 2020

(30) Foreign Application Priority Data
Mar. 2, 2018 (DE) 10 2018 203 158.4

(51) Int. Cl. D06F 58/20

(52) U.S. Cl. CPC D06F 58/206

(57) ABSTRACT

An appliance for drying laundry contains an open process air system having a drying chamber for receiving laundry to be dried, and a heat pump that is thermally coupled to the process air system. The heat pump has an evaporator serving as a heat sink for process air discharged from the drying chamber, and a condenser serving as a heat source for the process air to be supplied to the drying chamber. In order to improve a heat transfer between the process air system and the heat pump, and to minimize pressure losses within the process air system, the evaporator and the condenser are arranged laterally side-by-side and offset in height with respect to each other. One portion of a first process air duct extends above/below the condenser, and one portion of a second process air duct extends below/above the evaporator.

The invention relates to an appliance for drying laundry, comprising at least one open process air system having at least one drying chamber for receiving laundry to be dried and at least one heat pump that is thermally coupled to the process air system, which heat pump has at least one evaporator serving as a heat sink for process air discharged from the drying chamber and at least one condenser serving as a heat source for the process air to be supplied to the drying chamber.

Appliances for drying laundry are known in many embodiments. Known in particular are appliances for drying laundry which facilitate an open process air system having a drying chamber for receiving laundry to be dried and a heat recovery from the process air flowing in the process air system. Such an appliance can for example be designed as an exhaust air dryer with heat recovery. Corresponding appliances are for example known from DE 197 37 075 A1, DE 197 31 826 A1 and DE 30 00 865 A1. In this context the unit for heat recovery can be an individual heat exchanger thermally coupled to the process air system or a compressor heat pump thermally coupled to the process air system. In the latter case, heat is removed from the exhaust air coming from the drying chamber by means of an evaporator of the heat pump, and said heat is reintroduced into the process air entering into the process air system in a coolant circuit of the heat pump by means of a condenser of the heat pump. EP 2 037 034 B1 also discloses an exhaust air dryer with a heat pump and a cleaning device for cleaning the evaporator of the heat pump.

As an exhaust air dryer has an open process air system, with the exhaust air dryer as opposed to a condensation dryer with a closed process air guidance and heat recovery, sensible heat is also recovered in addition to latent heat. In addition the compressor power introduced into the process air via the condenser of the heat pump also increases the drying speed. As a result an exhaust air dryer with heat recovery can have lower consumption values than a condensation dryer in spite of a condensation effectiveness of less than 50%.

In a closed process air system the compressor power which is continuously introduced leads to an increasing warming of the condensation dryer. If this energy input is not in equilibrium with the energy losses occurring during a drying process, such as for example a component heating, losses due to heat radiation, convection or leakage, the process air system and the heat pump can overheat, thus reducing the efficiency of the heat pump. As a countermeasure to this, applications with actively cooled additional heat exchangers in the coolant circuit of the heat pump or with air-air heat exchangers in the process air are known.

As in an open process air system of an exhaust air dryer the temperature of the drawn-in process air remains practically constant and is not higher than the ambient temperature, no corresponding overheating occurs. The constantly low temperature level of the drawn-in ambient air leads to high efficiency levels of the heat pump. In contrast, the disadvantage of an overall energy balance of the installation location can exist as the generally warmer room air is exchanged several times with cooler outside air. DE 103 49 712 A1 discloses an exhaust air dryer with an adjustable recirculating air component. It is also known that exhaust air dryers with a heat pump and an auxiliary heater can achieve very high dehumidification performance.

DE 10 2010 028 741 A1 discloses possible arrangements of heat exchangers of a heat pump in conjunction with an exhaust air dryer with open process air system. In particular an arrangement of the heat exchangers in parallel one above the other and an arrangement of the heat exchangers in parallel side-by-side are disclosed. The standardized dimensions of tumble dryer housings on the European market result in significantly reduced inflow cross-sections compared to the usual arrangement of the heat exchangers which are in consecutive order in a heat exchanger with closed process air circuit as regards a process air flow. Due to additional partition walls or pipe bends, the inflow cross-sections can be less than 50% of the output variables. This strong reduction of inflow cross-sections leads at usual volume flows of 200 m³/h to 250 m³/h to pressure losses at the heat exchangers, which are not acceptable at over 300 Pa for the fan characteristics.

An object of the invention is to improve a heat transfer between a process air system and a heat pump of an appliance for drying laundry and to minimize pressure losses within the process air system.

This object is achieved by means of the independent claim. Advantageous embodiments are reproduced in the following description, the dependent claims and the FIGURE, wherein these embodiments both in their own right or in different combinations of at least two of these embodiments can represent a further developing, in particular also preferred or advantageous, aspect of the invention.

An inventive appliance for drying laundry comprises at least one open process air system having at least one drying chamber for receiving laundry to be dried and at least one heat pump that is thermally coupled to the process air system, which heat pump has at least one evaporator serving as a heat sink for process air discharged from the drying chamber and at least one condenser serving as a heat source for the process air to be supplied to the drying chamber. The evaporator and the condenser are arranged laterally side-by-side and offset in height with respect to each other, wherein either on the one hand one portion of a first process air duct connecting the drying chamber to the evaporator extends above the condenser and one portion of a second process air duct connecting the condenser to the drying chamber extends below the evaporator or on the other hand one portion of the first process air duct extends below the condenser and one portion of the second process air duct extends above the evaporator.

As a result of the inventive arrangement of the evaporator, the condenser and the portions of the process air ducts relative to one another, a larger inflow cross-section for the process air flowing toward the evaporator and a larger inflow cross-section for the process air flowing away from the condenser can be realized compared to the arrangement options of heat exchangers of a heat pump described in 201001572. As a result a maximum volumetric power density can be achieved while at the same time reducing pressure losses both on the coolant side as well as on the process air side without the dimensions of the appliance thereby having to be changed. In particular no or only minimal structural changes to a base unit are required. What is significant is that the heat transfer between a process air system and the heat pump can be improved and at the same time pressure losses within the process air system can be minimized.

The evaporator and the condenser are arranged laterally side-by-side in a direction perpendicular to the vertical axis of the appliance and offset in height with respect to each other in the direction of the vertical axis of the appliance. This means that either the evaporator is arranged higher than the condenser in relation to the vertical axis of the appliance or the condenser is arranged higher than the evaporator in relation to the vertical axis of the appliance. In the case of the first alternative the portion of the first process air duct extends above the condenser and the portion of the second process air duct extends below the evaporator. In the case of the second alternative the portion of the first process air duct extends below the condenser and the portion of the second process air duct extends above the evaporator. The fact that both of the heat exchangers, in other words the evaporator and the condenser, are arranged laterally side-by-side means that an underside of the respective heat exchanger arranged higher up is arranged lower than a top side of the respective heat exchanger arranged lower down. The two heat exchangers are preferably arranged laterally side-by-side in such a way that the two heat exchangers are arranged laterally side-by-side at a given distance from one another and therefore do not come into contact with one another laterally.

The open process air system is partially formed by the drying chamber for receiving laundry to be dried and has at least one process air fan for moving process air through process air ducts of the process air system connected communicatively to the drying chamber. The process air fan is in particular arranged on the second process air duct. The process air system can also have at least one process air filter which is arranged for example on the first process air duct. Furthermore the process air system can have an electric auxiliary heating unit which can be arranged on the second process air duct.

The heat pump is preferably directly thermally coupled with the process air system. In particular the evaporator and the condenser are thermally coupled with the process air system. The heat pump can be designed as a compressor heat pump and can correspondingly have at least one compressor for compressing the coolant of the heat pump and at least one expansion unit for expanding the coolant. The evaporator extracts heat (heat sink) from the process air discharged from the drying chamber while coolant within the evaporator is evaporated. The condenser supplies heat (heat source) to the process air supplied to the drying chamber while coolant within the condenser is condensed.

The appliance for drying laundry can be designed for example as a tumble dryer (exhaust air dryer), as a tumble dryer with an exhaust air drying function or as a drying cabinet with an exhaust air drying function.

According to an advantageous embodiment the evaporator and the condenser are arranged laterally at a distance from one another leaving a defined installation space, wherein the portion of the first process air duct extending above or below the condenser is connected communicatively to a supply portion of the first process air duct widening in the direction of the evaporator and connected to the evaporator, wherein the portion of the second process air duct extending below or above the evaporator is connected communicatively to a discharge portion of the second process air duct widening in the direction of the condenser and connected to the condenser, and wherein the supply portion and the discharge portion are arranged adjacent to one another in the direction of the appliance height and are at least largely arranged in the installation space between the evaporator and the condenser, and taper in opposite directions. The supply portion, via which the process air coming from the drying chamber is supplied to the evaporator, is preferably widened in such a way that its inlet opening arranged on the side of the evaporator has a cross-sectional surface which approximately or exactly corresponds as regards its size and shape to a lateral surface of the evaporator facing toward the supply portion. The discharge portion, via which the process air coming from the condenser is supplied to the drying chamber, is preferably widened in such a way that its inlet opening arranged on the side of the condenser has a cross-sectional surface which approximately or exactly corresponds as regards its size and shape to a lateral surface of the condenser facing toward the discharge portion. As the end portions (supply portion, discharge portion)—in part designed to be larger—of the process air ducts are largely or completely arranged in the installation space between the heat exchangers (evaporator, condenser) arranged laterally apart from one another and only the portion of the respective process air duct connected to the respective end portion, which has a lower installation height than the larger part of the respective end portion, is ducted above or below the respective heat exchanger, the heat exchangers and the portions of the process air ducts form a module, the height of which approximately corresponds to a conventional installation height which is usual for a module with corresponding functional components so that the module can be installed in the appliance without the dimensions of the appliance having to be changed for this purpose. In particular the two end portions (supply portion, discharge portion) of the process air ducts as a result of their offset or complementary tapering and their adjacent arrangement in the direction of the appliance height can largely or completely be arranged in the installation space between the evaporator and the condenser, thus saving space in the installation space. The widening of the end portions (supply portion, discharge portion) means that process air duct portions with a larger flow cross-section surface are made available and none of the volume relevant for the heat transfer performance within the process air system is lost. The larger flow cross-section surfaces oriented transversely to the respective process air flow allow an increase in the heat transfer performance and lower pressure losses within the process air system.

A further advantageous embodiment provides that an overall height of a first module formed from the evaporator and the portion of the second process air duct corresponds to an overall height of a second module formed from the condenser and the portion of the first process air duct. As a result the module formed from the heat exchangers (evaporator, condenser) and the portions of the process air ducts is the same height and is therefore configured approximately the same as a conventional module so that the module can be installed in a conventional appliance without significant changes having to be made to the appliance.

According to a further advantageous embodiment an overall height of a third module formed from the supply portion and the discharge portion corresponds to the overall height of the first module. As a result here too the module formed from the heat exchangers (evaporator, condenser) and the portions of the process air ducts is given an equal installation height so that the module can be installed in a manner corresponding to a conventional module.

The invention is explained below by way of example with reference to the attached FIGURE by means of a preferred embodiment. In the drawings:

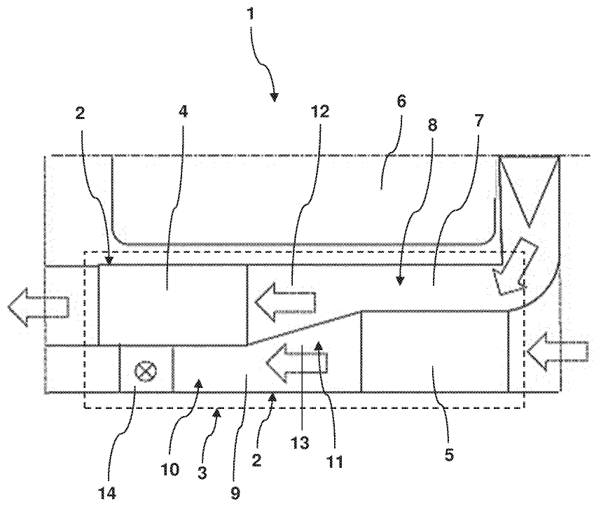

FIG. 1 shows a schematic sectional representation of an exemplary embodiment for an appliance according to the invention.

FIG. 1 shows a schematic sectional representation of an exemplary embodiment for an appliance 1 for drying laundry according to the invention.

The appliance 1 has an open process air system 2 having a drying chamber 6 for receiving laundry to be dried and a heat pump 3 that is thermally coupled to the process air system 2. The heat pump 3 has an evaporator 4 serving as a heat sink for the process air discharged from the drying chamber, at least one condenser 5 serving as a heat source for process air supplied to the drying chamber, a compressor (not shown), an expansion unit (not shown) and coolant ducts (not shown) connecting these components to one another.

The evaporator 4 and the condenser 5 are arranged laterally side-by-side and offset in height with respect to each other. In particular the evaporator 4 and the condenser 5 are arranged laterally apart from one another leaving a defined installation space 11. A portion 7 of a first process air duct 8 connecting the drying chamber 6 to the evaporator 4 extends above the condenser 5 and a portion 9 of a second process air duct 10 connecting the condenser 5 to the drying chamber 6 extends below the evaporator 4.

The portion 7 of the first process air duct 8 extending above the condenser 5 is connected communicatively to a supply portion 12 of the first process air duct 8 widening in the direction of the evaporator 4 and connected to the evaporator 4. The portion 9 of the second process air duct 10 extending below the evaporator 4 is connected communicatively to a discharge portion 13 of the second process air duct 10 widening in the direction of the condenser 5 and connected to the condenser 5. The supply portion 12 and the discharge portion 13 are arranged adjacent to one another in the direction of the appliance height and completely in the installation space 11 between the evaporator 4 and the condenser 5. In addition the supply portion 12 and the discharge portion 13 taper in opposite directions whereby the wall portions of the supply portion 12 and the discharge portion 13 arranged facing toward one another are arranged inclined in opposite directions in relation to a flow direction of the process air.

An overall height of a first module formed from the evaporator 4 and the portion 9 of the second process air duct 10 corresponds to an overall height of a second module formed from the condenser 5 and the portion 7 of the first process air duct 8. An overall height of a third module formed from the supply portion 12 and the discharge portion 13 corresponds to the overall height of the first module.

In a drying operation of the appliance 1 ambient air is drawn into the second process air duct 10 by means of a process air fan 14 arranged in the second process air duct 10, wherein the drawn-in ambient air enters into the appliance 1 at an air inlet opening (not shown) at a front wall (not shown) of the appliance 1 and then flows around or through the condenser 5. As a result the drawn-in ambient air is heated and it becomes process air. The process air flowing from the condenser 5 is drawn in by the portion 9 of the second process air duct 10 and is then introduced into the drying chamber 6 to dry the damp laundry located there. The process air laden with moisture and flowing from the drying chamber 6 flows into the first process air duct 8 and flows by means of the portion 7 of the first process air duct 8 to the evaporator 4. The process air then circulating around or through the evaporator 4 is cooled down by means of the evaporator 4, wherein at the same time moisture contained in the process air is condensed at the evaporator 4 and is collected and/or is continued to be used for flushing the evaporator 4 and/or the condenser 5. The process air flowing from the evaporator 4 then leaves the appliance 1.

An opening cross-sectional surface of the supply portion 12 at its end facing toward the evaporator 4 largely corresponds as regards its size and shape to the lateral surface of the evaporator 4 facing toward the supply portion 12. An opening cross-sectional surface of the discharge portion 13 at its end facing toward the condenser 5 largely corresponds as regards its size and shape to the lateral surface of the condenser 5 facing toward the discharge portion 13. As a result maximum flow cross-sections are made available in order to be able to make available a maximum heat transfer performance and to minimize pressure losses within the process air system 2.

### LIST OF REFERENCE CHARACTERS

1 Appliance
2 Process air system
3 Heat pump
4 Evaporator
5 Condenser
6 Drying chamber
7 Portion of 8
8 First process air duct
9 Portion of 10
10 Second process air duct
11 Installation space between 4 and 5
12 Supply portion of 8
13 Discharge portion of 10
14 Process air fan

1-4. (canceled)

5. An appliance for drying laundry, comprising:
at least one open process air system having at least one drying chamber for receiving the laundry to be dried and at least one heat pump that is thermally coupled to said open process air system, said at least one heat pump having at least one evaporator serving as a heat sink for process air discharged from said at least one drying chamber and at least one condenser serving as a heat source for the process air to be supplied to said at least one drying chamber, said at least one evaporator and said at least one condenser are disposed laterally side-by-side and offset in height in respect to each other; and
process air ducts including a first process air duct and a second process air duct, wherein either one portion of said first process air duct connecting said at least one drying chamber to said at least one evaporator extending above said at least one condenser and one portion of said second process air duct connecting said at least one condenser to said at least one drying chamber extending below said at least one evaporator or said one portion of said first process air duct extending below said at least one condenser and said one portion of said second process air duct extending above said at least one evaporator.

6. The appliance according to claim 5, wherein:
said first process air duct has a supply portion;
said second process air duct has a discharge portion;
said at least one evaporator and said at least one condenser are disposed laterally at a distance from one another leaving a defined installation space;
said one portion of said first process air duct extending above or below said at least one condenser is connected communicatively to said supply portion of said first process air duct and widening in a direction of said at least one evaporator and connected to said at least one evaporator;
said one portion of said second process air duct extending below or above said at least one evaporator is connected communicatively to said discharge portion of said second process air duct and widening in a direction of said at least one condenser and connected to said at least one condenser; and
said supply portion and said discharge portion are disposed adjacent to one another in a direction of an appliance height and are at least largely disposed in said defined installation space between said at least one evaporator and said at least one condenser, and taper in opposite directions.

7. The appliance according to claim 5, wherein an overall height of a first module formed from said at least one evaporator and said one portion of said second process air duct corresponds to an overall height of a second module formed from said at least one condenser and said one portion of said first process air duct.

8. The appliance according to claim 7, wherein an overall height of a third module formed from said supply portion and said discharge portion corresponds to the overall height of said first module.
